(19) United States
(12) Patent Application Publication
(10) Pub. No.: US 2013/0154984 A1
(43) Pub. Date: Jun. 20, 2013

(54) HAPTIC SYSTEM

(71) Applicant: Masahiko Gondo, Yamanashi (JP)

(72) Inventor: Masahiko Gondo, Yamanashi (JP)

(21) Appl. No.: 13/817,629

(22) PCT Filed: Aug. 19, 2011
(86) PCT No.: PCT/JP2011/068770

§ 371 Date: Feb. 19, 2013

(30) Foreign Application Priority Data
Aug. 20, 2010 (JP) 2010-185150

(51) Int. Cl. G06F 3/01

(52) U.S. Cl. CPC G06F 3/016
USPC 345/173

(57) ABSTRACT

This haptic system is constituted by being provided with a liquid crystal display or other panel-type display device (15), an information selection haptic panel (contact panel (18) etc.) which is set on the top surface of the panel-type display device (15), a wire-shaped shape memory alloy (23) which contracts upon electrification and heating to make the information selection haptic panel move, and an insulating heat conductor (24 etc.) which releases the heat generated by the wire-shaped shape memory alloy (23). This haptic system is built into a display and operating part of a smartphone (10) etc. When this display and operating part is operated by being contacted by a finger of an operator, the operator is given a clear click sensation based on the contraction and extension action of the wire-shaped shape memory alloy (23).

### TECHNICAL FIELD

The present invention relates to a haptic system, more particular a haptic system which gives an operator a clear “click” sensation in his or hers sense of touch when operating an operating part in a mobile phone, smartphone, or other electronic device by a contact operation by a finger and which has a compact structure.

### BACKGROUND ART

As actuators which make the operating surface of a touch panel move, in the past, there have been electromagnetic type actuators and piezoelectric type actuators. As an electromagnetic type actuator, there is the device which is disclosed in the Patent Literature 1, while as piezoelectric type actuators, there are the devices which are disclosed in the Patent Literatures 2 to 4. In addition, as prior art, the devices which are disclosed in the Patent Literatures 5 and 6 have been proposed.

The Patent Literatures 1 to 6 will be explained in more detail. In the haptic panel system which is described in the Patent Literature 1, an electromagnetic drive mechanism which is provided between a touch panel and a base member is used to make the touch panel depress when the touch panel is operated by a finger. In the input system etc. which is described in the Patent Literature 2, actuators for generating vibration are arranged at several locations of a touch panel and give tactile sensation to the fingertip due to vibration at the time of operation. In the operation input system which is described in the Patent Literature 3, an operating panel is supported by piezoelectric devices and the piezoelectric devices are driven to generate vibration when the operating surface of the operating panel is pressed by a finger. In the touch pad which is described in the Patent Literature 4 etc., actuators for generating vibration are attached to the back surface of the touch pad. In the method of giving a tactile sensation which is described in the Patent Literature 5 etc., actuators comprised of piezoelectric actuators are provided and are used to generate vibration to generate a tactile sensation. In the buttons etc. in the touch type input system which is described in the Patent Literature 6, at least one piezoelectric actuator is provided and that piezoelectric actuator is used to give the user a tactile sensation through the touch surface of the touch type input system.

### PRIOR ART LITERATURE

### Patent Literature

Patent Literature 1: Japanese Patent Publication No. 2006-146611 A1
Patent Literature 2: Japanese Patent Publication No. 2005-258666 A1
Patent Literature 3: Japanese Patent Publication No. 11-212725 A1
Patent Literature 4: Japanese Utility Model Registration No. 3085481
Patent Literature 5: Japanese Patent No. 4149926
Patent Literature 6: Japanese Patent Publication No. 2008-516348 A1

### SUMMARY OF INVENTION

### Technical Problem

In the prior arts which are described in the above-mentioned Patent Literatures 1 to 6, there were the following problems.

The haptic panel system which is described in the Patent Literature 1 has the defect that the touch panel can only move up or down and therefore the movement operation is restricted. Furthermore, it has the defect that the touch panel is provided with an electromagnetic drive mechanism, so the moving parts become heavy in weight and a large acceleration degree cannot be obtained. Furthermore, the stator side requires permanent magnets, so there is the problem that the weight increases overall and the size becomes large.

The input system which is described in the Patent Literature 2 etc. has the defect that it utilizes actuators for generating vibration, so the amplitude of the vibration is small and a large tactile sensation cannot be given. Further, the vibration is a continuous burst like waveform, so it is difficult to create a “cutoff” tactile sensation like the click of a switch. Furthermore, drive of actuators for generating vibration generally requires several hundred volts of voltage. Therefore, there was the defect that the drive circuit became large in size.

The operation input system which is described in the Patent Literature 3 uses piezoelectric devices to generate a tactile sensation corresponding to depression of a switch, but since it utilizes piezoelectric devices, could not easily generate a clear tactile sensation.

The touchpad which is described in Patent Literature 4 etc. uses actuators which are attached to the back surface of the touch pad to cause vibration so as to generate upward and downward movement and create a tactile sensation, so like with piezoelectric devices, it was difficult to generate a clear tactile sensation.

The method of giving a tactile sensation which is described in the Patent Literature 5 etc. uses actuators which are comprised of piezoelectric actuators etc. so as to generate vibration and thereby generate a tactile sensation, so in the same way as with piezoelectric devices, it was difficult to generate a clear tactile sensation.

The buttons etc. in the touch type input system which is described in the Patent Literature 6 use one or more piezoelectric actuators to generate a sense of touch by a tactile sensation, so like with piezoelectric devices, it was difficult to generate a clear tactile sensation.

As explained above, in the haptic systems which are used in conventional touchpanels etc., the actuators for creating the tactile sensation were designed to use electromagnetic systems or designed to use piezoelectric systems. However, actuators which utilize electromagnetic systems had the problems of the bulky size and heavy weight of the magnetic circuit parts. In particular, electromagnetic coils were provided at the contact panel, so the moving members became heavy in weight and it was difficult to secure a large acceleration degree.

Further, actuators which utilize piezoelectric systems have small piezoelectric members themselves, but only vibration is generated and the amplitude was only up to several μm at most, so a large tactile sensation could not be given. The vibration was of a continuous waveform with a burst like nature, so it was difficult to give a sharp “cutoff” tactile sensation like the click of a switch. Furthermore, driving piezoelectric actuators generally requires several hundred volts of voltage, so there was the defect that the drive circuit became large.

An object of the present invention, in consideration of the above problems, is to provide a haptic system which can give a clear click sensation to an operator by utilizing the contraction and extension action of a shape memory alloy when the operator touches the display and operating part of a mobile phone, smartphone, etc. with his or her finger to operate it and which can be made compact in structure. Another object of the present invention is to provide a haptic system which is small in actuator size, is good in response speed, is small in drive circuit as well, is low in cost, and is low in power consumption.

### Solution to Problem

The haptic system according to the present invention is configured as follows to achieve this object.

The haptic system is characterized by being provided with a panel-type display device, an information selection haptic panel which is set on a top surface of the panel-type display device, a shape memory alloy which contracts upon electrification and heating to make the information selection haptic panel move, and an insulating heat conductor which disperses heat which was generated by the shape memory alloy.

The above haptic system is configured to instantaneously move the information selection haptic panel which has the haptic function in the horizontal direction or push-in direction to generate a click sensation. It realizes movement of the information selection haptic panel by utilizing the contraction and extension function of a wire-shaped shape memory alloy, for example. By giving a good heat release property to the shape memory alloy, the response in the deformation operation of the shape memory alloy is improved and therefore the click sensation and operating feeling are improved. Further, it is possible to build in the shape memory alloy, the mechanism for electrification of the shape memory alloy, and the mechanism for release of heat (heat sink) by a compact constitution in a smartphone or other small sized electronic device.

In the above constitution, preferably the system is comprised of an information selection haptic panel which slides with respect to a display surf ace of the panel-type display device, an insulating heat conductor which is provided at a back surface side of the panel-type display device and which has a curved surface which the shape memory alloy contacts when contracting, wire links which are connected to the information selection haptic panel, and a shape memory alloy which contracts to make the information selection haptic panel move.

In the above constitution, preferably the system is comprised of an insulating heat conductor which has a curved shape in a direction vertical to a direction of movement of the information selection haptic panel, is connected the information selection haptic panel, and is contacted at the curved surface by the shape memory alloy when it contracts.

In the above constitution, preferably the system is comprised of a first insulating heat conductor which has a plurality of relief curved shapes in a direction of movement of the information selection haptic panel and which is connected to the information selection haptic panel, a second insulating heat conductor which faces the first insulating heat conductor across an interval and which has a plurality of relief curved shapes, and a shape memory alloy which is laid between the first insulating heat conductor and the second insulating heat conductor and which contacts projecting parts of the first and second insulating heat conductors.

In the above constitution, preferably the system is comprised of an information selection haptic panel which slides in parallel with respect to a display surface of the panel-type display device, a first insulating heat conductor which is connected to the information selection haptic panel, a second insulating heat conductor which is overlaid facing the same, and a shape memory alloy which is arranged between the first and second insulating heat conductors and makes the first insulating heat conductor and the information selection haptic panel move in parallel when the shape memory alloy contracts.

In the above constitution, preferably the system is comprised of an information selection haptic panel which slides with respect to a display surface of the panel-type display device, a substantially round rod shaped first insulating heat conductor which is connected to the information selection haptic panel and a substantially round rod shaped second insulating heat conductor which is arranged in parallel with this, and a shape memory alloy which is wound around the first and second insulating heat conductors.

In the above constitution, preferably the system is comprised of an information selection haptic panel which is elastically supported slanted in direction with respect to a display surface of the panel-type display device, a substantially round rod shaped first insulating heat conductor and a substantially round rod shaped second insulating heat conductor which is arranged in parallel with this in a slanted direction when viewed from a cross-sectional direction, and a shape memory alloy which is wound around the first and second insulating heat conductors.

In the above constitution, preferably the system is comprised of an information selection haptic panel which is elastically supported so as to move in a direction vertical to a display surface of the panel-type display device, a substantially round rod shaped first insulating heat conductor which is connected to the information selection haptic panel and a substantially round rod shaped second insulating heat conductor which is arranged in parallel with the same, and a shape memory alloy which is wound around the first and second insulating heat conductors.

In the above constitution, preferably the shape memory alloy is wound in a spiral shape or a figure eight shape.

In the above constitution, preferably the first and second insulating heat conductors have cross-sectional surface shapes of substantially circular or semicircular shapes.

Further, another haptic system is provided with a panel-type display device, an information selection haptic panel which is arranged on a top surface of the panel-type display device and which has a touch panel for selection of information and a contact panel which is touched by a finger of an operator, a shape memory alloy which contracts upon electrification and heating to make the information selection haptic panel displace, and an insulating heat conductor which disperses heat which was generated by the shape memory alloy, wherein the approach of the finger of the operator to the touch panel causes the shape memory alloy to be electrified and heated and causes the information selection haptic panel to displace.

In the above constitutions, preferably the information selection haptic panel is a contact panel or a panel which is comprised of the contact panel and touch panel.

In the above constitution, preferably, at the information selection haptic panel, between the touch panel and the contact panel, only the contact panel is made to displace by the shape memory alloy.

In the above constitution, preferably the panel-type display device is fastened to the information selection haptic panel and moves simultaneously with movement of the information selection haptic panel.

### Advantageous Effects of Invention

According to the haptic system of the present invention, an information selection haptic panel having a contact function, which is provided movably at the front surface part of a mobile phone, smartphone, etc., is made to quickly move in an impact manner by a contraction action of a wire-shaped shape memory alloy etc. by electrification and heating by a heat conductor which effectively releases the heat, so it is possible to give a clear click sensation in the sense of touch of the operator and, furthermore, it is possible to assemble the system into a mobile phone etc. by a compact structure.

Since the contraction and extension action of a shape memory alloy provided with a heat dispersion part is used, it is possible to make the actuator part for moving the information selection haptic panel small in size and fast in response speed, small in drive circuit as well, low in cost, and low in power consumption.

According to the haptic system of the present invention, in the click generating mechanism for generating a clear click sensation at the information selection haptic panel, the heat release action of the shape memory alloy is improved, so it is possible to use various types of structures and shapes of insulating heat conductors and give a high design freedom in accordance with the product concerned.

### BRIEF DESCRIPTION OF DRAWINGS

FIG. 1 This is a longitudinal cross-sectional view of a smartphone to which a haptic system according to a first embodiment of the present invention is applied.

FIG. 2 This is a cross-sectional view along the line A-A in FIG. 1.

FIG. 3 This is a view of the relationship of operation of the contact panel with respect to the printed circuit board in the smartphone in the constitution of the first embodiment seen from the back surface side and shows a comparison between a state (A) of the wire-shaped shape memory alloy extended and a state (B) of it contracted.

FIG. 4 This is a cross-sectional view along the line B-B in FIG. 3 (A).

FIG. 5 This is a view which shows a power feed circuit to the wire-shaped shape memory alloy.

FIG. 6 This is a view of the relationship of operation of the contact panel with respect to the printed circuit board in the smartphone in the constitution of the haptic system according to a second embodiment of the present invention and shows a comparison between a state (A) of the wire-shaped shape memory alloy extended and a state (B) of it contracted.

FIG. 7 This is a cross-sectional view along the line C-C in FIG. 6 (A).

FIG. 8 This is a view which explains the state of change of linkage wires when the wire-shaped shape memory alloy contracts.

FIG. 9 This is a perspective view of a printed circuit board and contact panel as seen from the front surface side in the constitution of a haptic system according to a third embodiment of the present invention.

FIG. 10 This is a view which explains examples of operation (A) and (B) of a contact panel accompanying contraction of the wire-shaped shape memory alloy in the constitution of the third embodiment.

FIG. 11 This is a perspective view of a contact panel and insulating heat conductor as seen from the front surface side in the constitution of a haptic system according to a fourth embodiment of the present invention.

FIG. 12 This is a view which explains examples of operation (A) and (B) of an insulating heat conductor and contact panel accompanying contraction of the wire-shaped shape memory alloy in the constitution of the fourth embodiment.

FIG. 13 This is a perspective view of a printed circuit board, contact panel, and insulating heat conductor as seen from the front surface side in the constitution of a haptic system according to a fifth embodiment of the present invention.

FIG. 14 This is a horizontal cross-sectional view which shows the relationship of layout of fixed side and moving side insulating heat conductors and a wire-shaped shape memory alloy in a smartphone in the constitution of the fifth embodiment.

FIG. 15 This is a perspective view of a printed circuit board and contact panel as seen from the front surface side in the constitution of a haptic system according to a sixth embodiment of the present invention.

FIG. 16 This is a partial cross-sectional view which shows the relationship between two insulating heat conductors and a wire-shaped shape memory alloy in the constitution of the sixth embodiment.

FIG. 17 This is a view which explains examples of operation (A) and (B) of a contact panel accompanying contraction of the wire-shaped shape memory alloy in the constitution of the sixth embodiment.

FIG. 18 This is a view which shows a different method of winding the wire-shaped shape memory alloy in the constitution of the sixth embodiment.

FIG. 19 This is a perspective view of a printed circuit board, contact panel, and mechanism part giving a click sensation as seen from the front surface side in the constitution of a haptic system according to a seventh embodiment of the present invention.

FIG. 20 This is a side view of the structure which is shown in FIG. 19 seen from the side.

FIG. 21 This is a perspective view of a printed circuit board and contact panel as seen from the front surface side in the constitution of a haptic system according to an eighth embodiment of the present invention (push-in type).

FIG. 22 This is a view which explains examples of operation (A) and (B) of a contact panel accompanying contraction of the wire-shaped shape memory alloy in the constitution of the eighth embodiment.

FIG. 23 This is a partial perspective view which shows another structure of a click generating mechanism in the configuration of the eighth embodiment.

FIG. 24 This is a partial longitudinal cross-sectional view which shows the relationship among a printed circuit board, contact panel, and click generating mechanism for the constitution of the haptic system according to a ninth embodiment of the present invention (push-in type).

FIG. 25 This is a partial longitudinal cross-sectional view which shows an initial operation state of contacting the contact panel so that a fingertip touches an electrode and pushing in the contact panel in the structure which is shown in FIG. 24.

FIG. 26 This is a partial longitudinal cross-sectional view which shows the state where the touch action of the fingertip with an electrode further advances and a click generating mechanism operates in the structure which is shown in FIG. 24.

FIG. 27 This is a perspective view of principal parts for explaining a first example of the constitution of an information selection haptic panel and a method of driving displacement.

FIG. 28 This is a perspective view of principal parts for explaining a second example of the constitution of an information selection haptic panel and a method of driving displacement.

FIG. 29 This is a perspective view of principal parts for explaining a third example of the constitution of an information selection haptic panel and a method of driving displacement.

### DESCRIPTION OF EMBODIMENTS

Below, preferred embodiments (examples) of the present invention will be explained based on the drawings.

The haptic system according to the present invention generally can be applied to a mobile phone, smartphone, electronic book reader, or other portable electronic device which has, at its front surface part, a liquid crystal display or organic EL display or other panel-type display device and touch panel etc. forming a display and operating part and which is designed to enable operation of an operating part by a contact operation by a finger at the display and operating part. In the explanation of this embodiment, in particular, the example of application of the haptic system according to the present invention to a smartphone will be explained. According to this haptic system, the fingertip of an operator is given a clear click sensation (physical operating feeling). As the structural part which generates a click sensation, an information selection haptic panel which instantaneously operates in a predetermined direction is provided at the front surface part of the smartphone.

The “information selection haptic panel” is a panel member which has the function of generating a pseudo click sensation (contact function). An information selection haptic panel is typically formed by a contact panel. Further, an information selection haptic panel may also be formed by a panel which is comprised of a contact panel and the above touch panel overlaid. Furthermore, a touch panel alone may also be used as an information selection haptic panel. In the explanation of the embodiments below, the explanation will be given with reference to the example of mainly a contact panel as an “information selection haptic panel”.

### First Embodiment

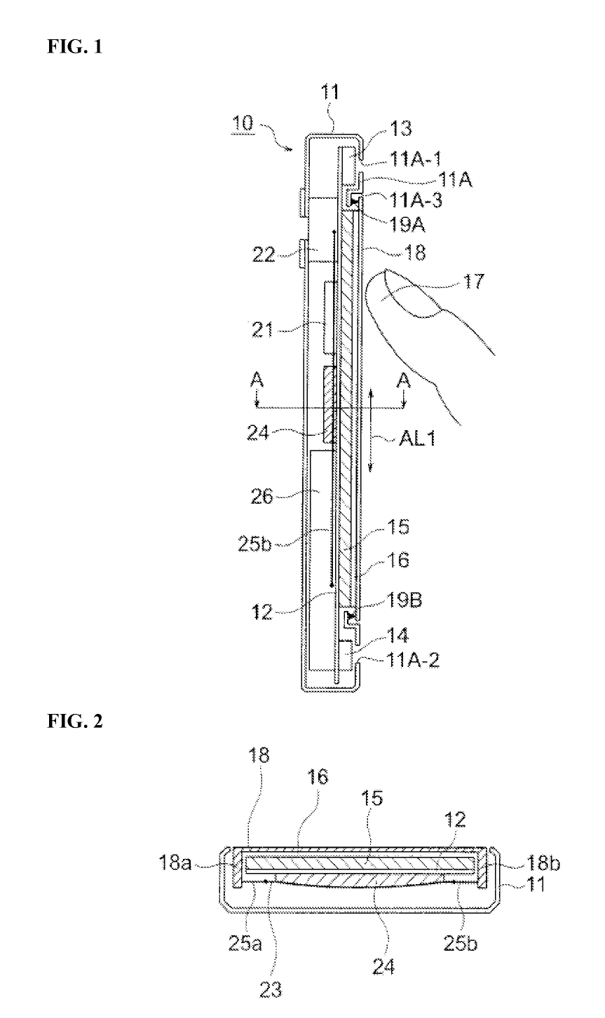

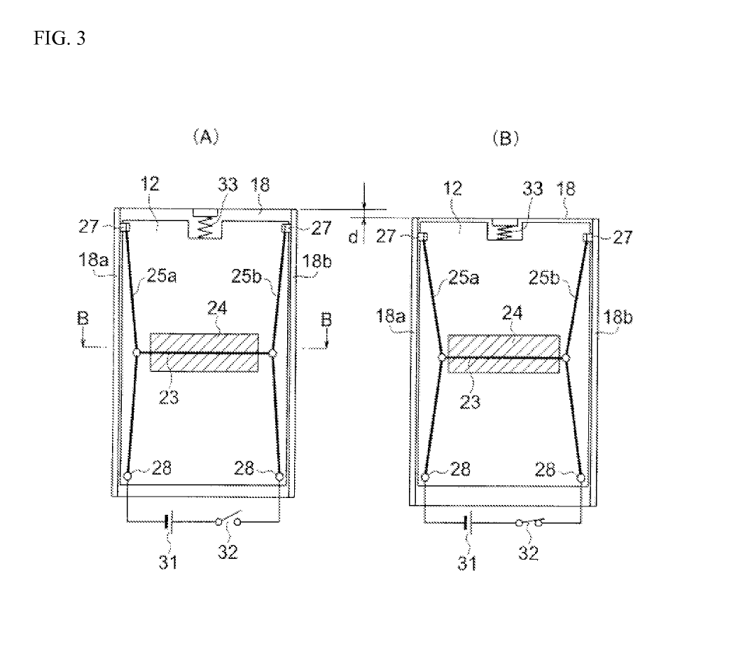

Referring to FIG. 1 to FIG. 5, a first embodiment of a haptic system according to the present invention will be explained. This first embodiment is structured to generate a horizontal type click sensation. Here, a “horizontal type” means the contact panel moves in its planar direction (direction parallel to planar direction of front surface part of smartphone). FIG. 1 is a longitudinal cross-sectional view along the long side direction which shows the structure of principal parts relating to the haptic system inside of a smartphone, while FIG. 2 is a cross-sectional view along the line A-A in FIG. 1. Further, FIG. 3 to FIG. 5 show the mechanism of a principal part of the haptic system according to the present embodiment, that is, the wire link system mechanism. Note that FIG. 3 is a view of the relationship of the operation of the contact panel with respect to the printed circuit board at the inside of the smartphone as seen from the back surface side and shows the wire-shaped shape memory alloy while comparing the state (A) where it is extended and the state (B) where it is contracted.

At the inside of a relatively thin thickness box-shaped container 11 of the smartphone 10, a printed circuit board 12 is arranged. At the front surface side of this printed circuit board 12, a small sized speaker 13 is provided at the top part, while a small sized microphone 14 is provided at the bottom part. Furthermore, a panel-type display device 15 is provided at the entire region at the substantial center part. The speaker 13 and microphone 14 approach the front surface area of the smartphone 10 via through holes 11A-1, 11A-2 which are formed in the front surface wall 11A of the box-shaped container 11. At the front surface of the panel-type display device 15, a transparent touch panel (contact panel) 16 is provided. The display screen at the front surface of the panel-type display device 15 approaches the front surface area of the smartphone 10 via the touch panel 16. The panel-type display device 15 and the touch panel 16 are formed at the front surface of the smartphone 10 via an opening part 11A-3 which is formed at the front surface wall 11A of the box-shaped container 11. At a defined two-dimensional area of the surface of the touch panel 16, a coordinate system is set. As shown in FIG. 1, when a person uses his or her fingertip 17 to touch an object which is displayed on the panel-type display device 15, a necessary instruction signal (command signal) is input in accordance with the operational content corresponding to the touched location. The touch panel 16 functions as an operating part. At the front surface side of the touch panel 16, further a transparent contact panel (contact panel) 18 is arranged. By the contact panel 18 being operated in a predetermined direction, the fingertip 17 of the operator is given a kinetic operating feeling (click sensation) in a pseudo manner. The contact panel 18, in the constitution of FIG. 1, is attached while supported at its top edge and bottom edge by hinges 19A, 19B. Further, the left and right edges of the contact panel 18, as shown in FIG. 2, are bent inward whereby bent parts 18a, 18b are formed. The contact panel 18 is attached so as to cover the touch panel 16. In the smartphone 10, the printed circuit board 12 which is provided at the inside of the box-shaped container 11 is not moved and is attached in a fastened state. Therefore, the panel-type display device 15 and touch panel 16 which are fastened to the printed circuit board 12 are also arranged in a fastened state. The contact panel 18 is attached to these so as to be able to move in the up-down direction (direction of the arrow AL1) in FIG. 1. The moving member constituted by the contact panel 18 is lightened in weight so as to easily move.

At the back surface of the printed circuit board 12, an IC chip 21 which contains a built in processing unit and memory, camera 22, wire-shaped shape memory alloy 23, insulating heat conductor (heat sink) 24, linkage wires 25a, 25b, and battery 26 are provided. Note that, in this embodiment, the explanation will be given with reference to a wire-shaped shape memory alloy 23. The shape memory alloy is not limited to a wire shape however.

The processing unit of the IC chip 21 uses the various types of programs and data which are stored in the memory as the basis to perform various types of functions which are designed as functions on the smartphone 10. The camera 22 is one envisioning assembly into the smartphone 10.

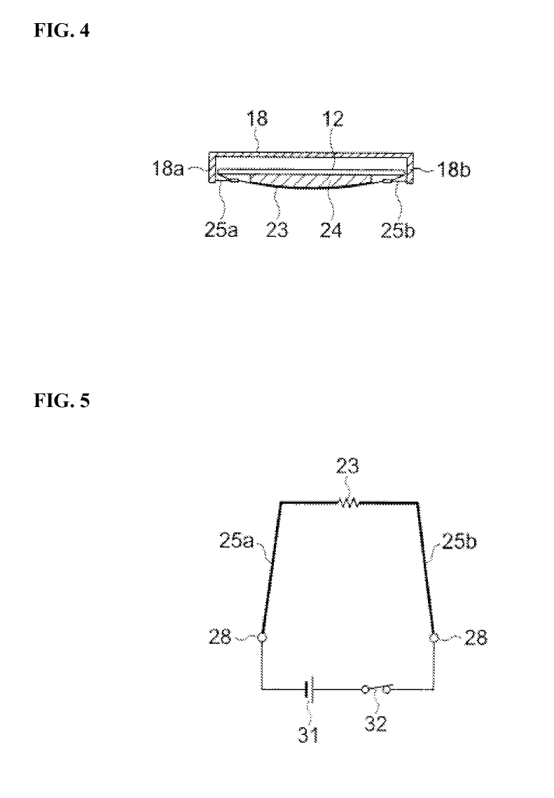

The insulating heat conductor 24, as shown in FIG. 3 and FIG. 4, is fastened at the approximate center part of the back surface of the printed circuit board 12 at its flat surface part of the front surface side, has a rectangular shape when seen from the back surface side, and is curved in its long direction (width direction of the printed circuit board 12) at the surface of its back surface side (back surface). At the back surface of the insulating heat conductor 24, the wire-shaped shape memory alloy 23 is arranged so as to follow the curved shape of the curved part. The two ends of the wire-shaped shape memory alloy 23 are connected to the center parts of the linkage wires 25a, 25b which are arranged at the two sides toward the long direction of the printed circuit board 12.

As shown in FIG. 3, two linkage wires 25a, 25b are respectively fastened at their top ends 27 to the inside surfaces of the bent parts 18a, 18b of the contact panel 18 and are fastened at their bottom ends 28 at locations near the bottom side corners of the printed circuit board 12. At the back surface side of the printed circuit board 12, linkage wires 25a, 25b are arranged along the left and right sides. The approximate center parts of the two linkage wires 25a, 25b are connected by the wire-shaped shape memory alloy 23 resulting in an H-shape arrangement as a whole. Between the bottom ends 28 of the linkage wires 25a, 25b, a power source 31 and a switch 32 are connected. The switch 32 is configured by a semiconductor switching device which is turned on by being given a signal from the outside. If the switch 32 is turned on, as shown in FIG. 5, the wire-shaped shape memory alloy 23 is supplied with current through the linkage wires 25a, 25b. If the wire-shaped shape memory alloy 23 is electrified, the wire-shaped shape memory alloy 23 contracts. It contracts by for example about 4% with respect to the original overall length. If the switch 32 is turned off and the wire-shaped shape memory alloy 23 is no longer electrified, the heat which is generated at the wire-shaped shape memory alloy 23 is dispersed through the insulating heat conductor 24 and the wire-shaped shape memory alloy 23 extends and returns to its original state.

As shown in FIG. 3, in the attachment structure inside the box-shaped container 11 of the smartphone 10, a compression spring 33 is provided between the top side part of the printed circuit board 12 and the top side part of the contact panel 18. Due to this compression spring 33, the contact panel 18 is biased upward from the printed circuit board 12. If the wire-shaped shape memory alloy 23 contracts by being electrified, the left and right linkage wires 25a, 25b are pulled and, as a result, the contact panel 18 moves downward by exactly the distance “d” against the compression spring 33. If the electrification is ended and the wire-shaped shape memory alloy 23 extends to return to its original length, the contact panel 18 is pushed by the compression spring 33 and returns to its original position. If the wire-shaped shape memory alloy 23 is instantaneously electrified, the contact panel 18 is also instantaneously moved.

The operation for turning on the switch 32 for electrification and heating of the wire-shaped shape memory alloy 23 causing the instantaneous operation at the contact panel 18 is performed each time the operator of the smartphone 10 touches the panel by his or her fingertip 17. That is, the touch panel 16 being touched by a fingertip 17 is detected, the switch 32 is turned on, the wire-shaped shape memory alloy 23 is electrified and the contact panel 18 is made to instantaneously operate. Due to this, the haptic action based on the instantaneous operation of the contact panel 18 enables a physical operating feeling to be given to the fingertip 17. The shape memory alloy 23 finishes contracting within several milliseconds due to a large current being instantaneously supplied. After that, the insulating heat conductor is used to efficiently disperse the heat, so the alloy immediately extends and returns to its original length. This change in length becomes a change in movement of the contact panel. By the sudden movement, an operation similar to a “click” sensation of the switch results. Further, the surface by which the insulating heat conductor 24 contacts the shape memory alloy 23 is a gently curved surface, so even after contraction of the shape memory alloy 23, that curved surface is firmly contacted and heat is reliably dispersed.

### Second Embodiment

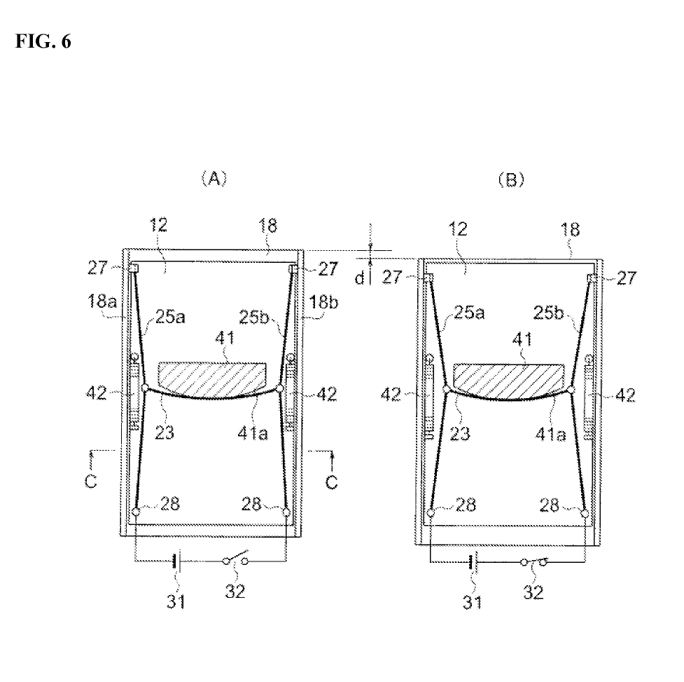

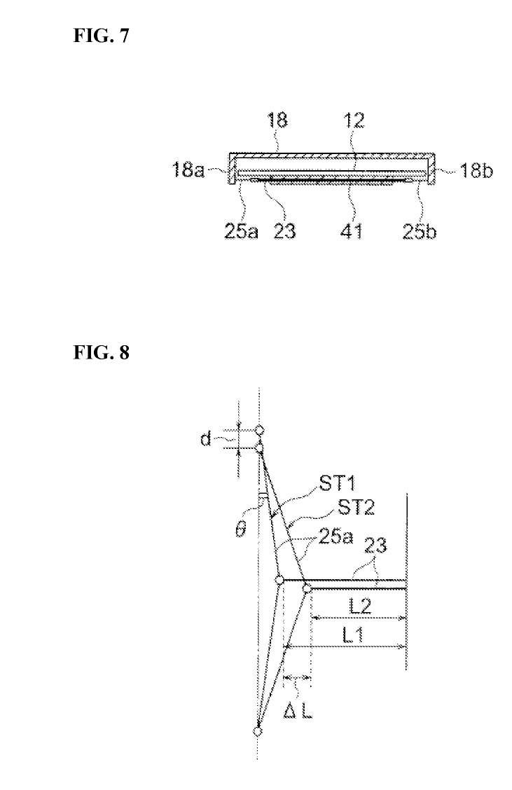

Referring to FIG. 6 to FIG. 8, a second embodiment of the haptic system according to the present invention will be explained. FIG. 6 is a view which is similar to FIG. 3, while FIG. 7 is a view which is similar to FIG. 4. Further, FIG. 8 is a view which explains the action due to linkage wires. In FIG. 6 to FIG. 8, components which are substantially the same as components which were explained in the first embodiment are assigned the same reference notations.

The constitution of the second embodiment, compared with the constitution of the first embodiment, differs in the shape of the insulating heat conductor, differs in the relationship of arrangement of the insulating heat conductor and the wire-shaped shape memory alloy, and, furthermore, differs in the contact panel being pulled by springs. The rest of the constitution in the second embodiment is the same as the case of the first embodiment.

An insulating heat conductor 41, as shown in FIG. 6 and FIG. 8, has a flat plate-shaped shape and is formed with a curved part 41a at its bottom side. A wire-shaped shape memory alloy 23 is arranged in contact along the curve of the curved part 41a of the insulating heat conductor 41. Further, a printed circuit board 12 and a contact panel 18 are coupled by two left and right extension springs 42. Therefore, as shown in FIG. 6 (A), in the normal state, the contact panel 18 is at a position pulled upward. At this time, as shown in FIG. 6 (A), the wire-shaped shape memory alloy 23 is in a state where it contacts the curved bottom surface of the insulating heat conductor 41 (curved part 41a).

In the above state, if turning the switch 32 on, as shown in FIG. 6 (B), the wire-shaped shape memory alloy 23 contracts, the linkage wires 25a, 25b are pulled, and, as a result, the contact panel 18 is moved downward by exactly the distance “d” against the extension springs 42. If the switch 32 is turned back from on, the heat of the wire-shaped shape memory alloy 23 is released through the insulating heat conductor 41 and the alloy immediately returns to the original state which is shown in FIG. 6 (A).

According to the constitution of the second embodiment, there is the advantage that the amount by which the insulating heat conductor 41 sticks out at the back surface side becomes smaller. Note that above, the bottom surface was made a curved surface, but the top surface may also be made a curved surface. In the same way as the first embodiment, even after contraction of the shape memory alloy 23, the curved surface is firmly contacted and heat is reliably dispersed.

In FIG. 8, the displacement of the wire-shaped shape memory alloy 23 and the linkage wires 25a, 25b in the constitutions of the first and second embodiments is shown. Before the wire-shaped shape memory alloy 23 is electrified, it is in the state of ST1, while when electrified, it is in the state of ST2. In the state ST1, it is a wire-shaped shape memory alloy 23 of the length L1, while in the state ST2, it becomes a wire-shaped shape memory alloy 23 of a length L2. The difference ΔL arises, whereby the angle θ becomes greater and displacement by the distance “d” occurs. For example, if ΔL is 1.5 mm, the distance “d” becomes about 0.3 mm.

This is because, in the same way as the lever principle, the smaller the working distance, the greater the force generated becomes in inverse proportion to that distance. To generate a click sensation, a working distance of as little as 0.3 mm is sufficient. Due to this force increasing mechanism, the contraction force of the shape memory alloy 23 can be increased and even if the operator strongly presses against the panel surface, the panel can be made to slide overcoming this. This can be said to be one type of displacement reduction and force increasing mechanism.

### Third Embodiment

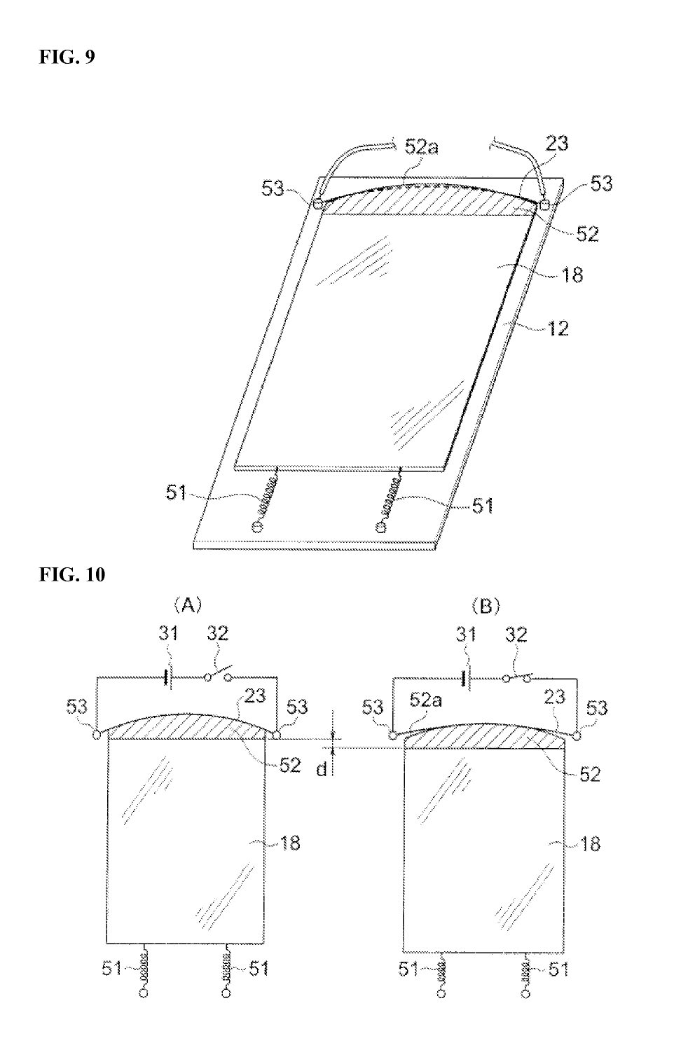

Referring to FIG. 9 and FIG. 10, a third embodiment of the haptic system according to the present invention will be explained. FIG. 9 is a perspective view of a printed circuit board 12 and a contact panel 18 seen from the front side, while FIG. 10 is view which explains the operation of the contact panel 18. In FIG. 9 and FIG. 10, components which are substantially the same as components which were explained in the first embodiment are assigned the same reference notations.

In this embodiment, an insulating heat conductor is arranged at the front surface side of a printed circuit board 12. A contact panel 18 which is arranged at a front surface side of the printed circuit board 12 is attached by two compression springs 51 so as to be biased upward. First ends of the compression springs 51 are fixed to the printed circuit board 12, while the other ends are fixed to the bottom side part of a contact panel 18. Further, along the top side of the contact panel 18, an insulating heat conductor 52 which has an arc part 52a at the top side part is fastened. At the arc part 52a of the top side of the insulating heat conductor 52, a wire-shaped shape memory alloy 23 is arranged in contact with it. The two ends of the wire-shaped shape memory alloy 23 are fastened to the printed circuit board 12. Reference numeral 53 is a fastening terminal. The compression spring 51 is used to bias the contact panel 18 and insulating heat conductor 52, whereupon the arc part 52a of the insulating heat conductor 52 pushes against the wire-shaped shape memory alloy 23. The contact panel 18 can freely move in the up-down direction with respect to the printed circuit board 12 due to the attachment relationship at the box-shaped container 11, but is restricted in movement in the left-right lateral direction and front-back direction.

In the above constitution, in the state which is shown in FIG. 10 (A) where the wire-shaped shape memory alloy 23 is electrified, if the switch 32 is turned on and the wire-shaped shape memory alloy 23 is electrified and heated, as shown in FIG. 10 (B), the wire-shaped shape memory alloy 23 contracts, the insulating heat conductor 24 is pushed down, and the contact panel 18 and insulating heat conductor 24 displace downward by exactly the distance “d”. If the switch 32 is turned off, the state which is shown in FIG. 10 (A) is immediately returned to.

According to this embodiment, it is not necessary to use a mechanism of linkage wires, so the structure can be simplified. The contact panel 18 can be directly pushed down by the contraction action of the wire-shaped shape memory alloy which contacts the arc part 52a of the insulating heat conductor 52, so a small force can be used to move it by a large distance.

### Fourth Embodiment

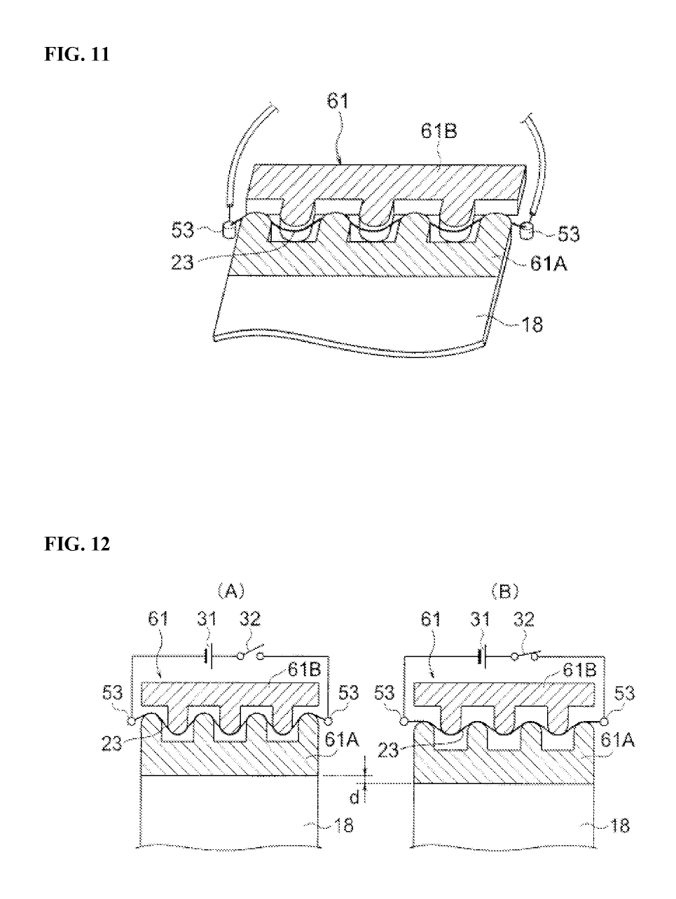

Referring to FIG. 11 and FIG. 12, a fourth embodiment of the haptic system according to the present invention will be explained. This fourth embodiment is a modification of the third embodiment. As shown in FIG. 11, an insulating heat conductor 61 of this embodiment is comprised of two members 61A, 61B. The member 61B is fastened to a printed circuit board 12. The member 61A is fastened to the top side part of the contact panel 18. In the insulating heat conductor 61, at the facing side parts of the member 61A and the member 61B, relief shapes are formed. The front ends of the projecting parts are formed in arc shapes. Further, the facing side parts of the members 61A, 61B grip a wire-shaped shape memory alloy 23. The rest of the configuration is the same as the configuration which is explained in the third embodiment.

FIG. 12, like FIG. 10, shows the operation of the contact panel 18, wherein (A) shows the state where the wire-shaped shape memory alloy 23 is not electrified and the contact panel 18 is biased by the above-mentioned compression springs 51 upward in FIG. 12 and (B) shows the state where a switch 32 is turned on so that the wire-shaped shape memory alloy 23 is electrified and heated and the contact panel 18 and member 61A of the insulating heat conductor 61 are pushed down by exactly the di stance “d”.

If making the shape memory alloy 23 the same size and length compared with the third embodiment, the distance of movement of the contact panel 18 becomes shorter and the force which is generated becomes greater and can overcome the force by which the operator pushes the contact panel and make the contact panel 18 move.

In the explanation which uses FIG. 11 and FIG. 12, the contact panel 18 moves in parallel with the panel surface, but while not illustrated, by attaching the two insulating heat conductors 61A and 61B to be vertical to the panel surface of the contact panel 18 in positional relationship, it is possible to make this movement in the up-down direction (the thickness direction). Note that, the insulating heat conductors 61A, 61B have front ends of the projecting parts formed into arc shapes. There are a plurality of these projecting shapes. It is also possible to form the projecting parts independently by metal (conductive material) and connect these by an insulating resin etc. In this case, the parts of the insulating heat conductors at which the wire-shaped shape memory alloy 23 contact the projecting parts are electrically connected, but overall the projecting parts are isolated, so the conductors function as insulating heat conductors.

### Fifth Embodiment

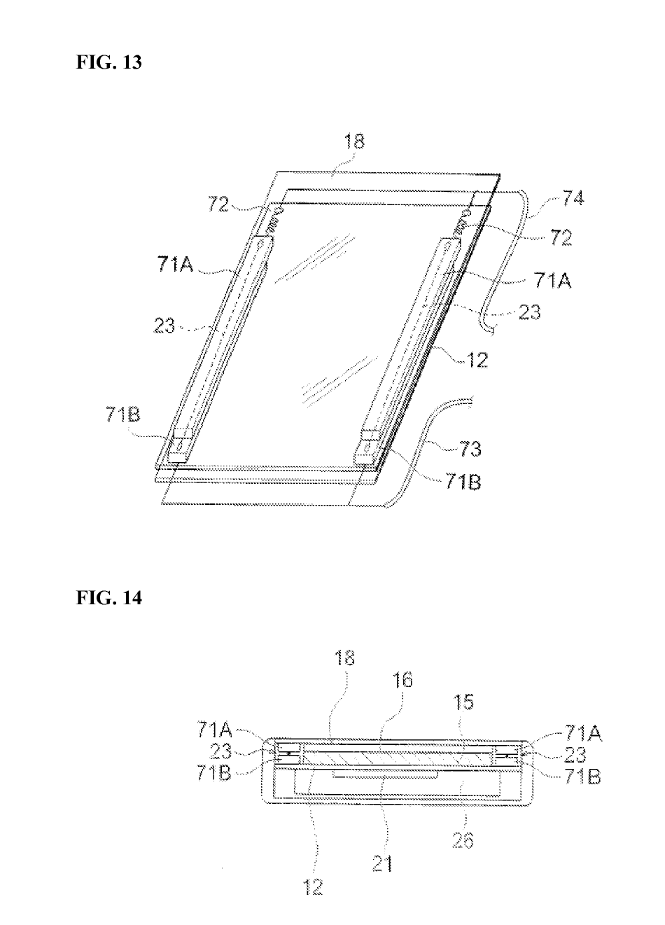

Referring to FIG. 13 and FIG. 14, a fifth embodiment of the haptic system according to the present invention will be explained. FIG. 13 is a perspective view of a printed circuit board 12, contact panel 18, and drive mechanism seen from the front side. In FIG. 13, the contact panel 18 is transparent, so the bottom side is visible through it. FIG. 14 is a lateral cross-sectional view of a smartphone 10 according to the fifth embodiment and is similar to FIG. 2. In this embodiment, a sliding type drive mechanism is used to make the contact panel 18 move.

As shown in FIG. 14, between the printed circuit board 12 and the contact panel 18, a panel-type display device 15 and a touch panel 16 are arranged in an overlaid state. Furthermore, between the printed circuit board 12 and the contact panel 18 at the left and right side parts, insulating heat conductors 71B which are fastened to the printed circuit board 12 and insulating heat conductors 71A which are fastened to the contact panel 18 are arranged. The insulating heat conductors 71B are fixed side members (below, referred to as the “fixed side insulating heat conductors 71B”), while the insulating heat conductors 71A are moving side members (below, referred to as the “moving side insulating heat conductors 71A”). The fixed side insulating heat conductors 71B and the moving side insulating heat conductors 71A have predetermined lengths along the left and right sides of the printed circuit board 12 etc. and are arranged overlaid. Between the fixed side insulating heat conductors 71B and the moving side insulating heat conductors 71A, wire-shaped shape memory alloys 23 are arranged in a gripped state. The bottom ends of the wire-shaped shape memory alloys 23 are connected to the bottom end parts of the fixed side insulating heat conductors 71B, while the top ends of the wire-shaped shape memory alloys 23 are connected to the top end parts of the moving side insulating heat conductors 71A. Furthermore, the two ends of the wire-shaped shape memory alloys 23 at the two sides are respectively connected to extension springs (coil springs) 72 and are pulled by the extension springs 72. As a result, the contact panel 18 itself is pulled by the extension springs 72. The two wire-shaped shape memory alloys 23 are designed to be able to be electrified by an electrical cord 73 which is connected to the bottom ends of the wire-shaped shape memory alloys 23 and an electrical cord 74 which is connected to the top ends of the extension springs 72.

In this embodiment, in the state where the wire-shaped shape memory alloys 23 are not electrified, the contact panel 18 is in a state pulled upward by the extension springs 72. If the wire-shaped shape memory alloys 23 are electrified, heat is generated and the wire-shaped shape memory alloys 23 contract whereby the contact panel 18 is pushed downward.

### Sixth Embodiment

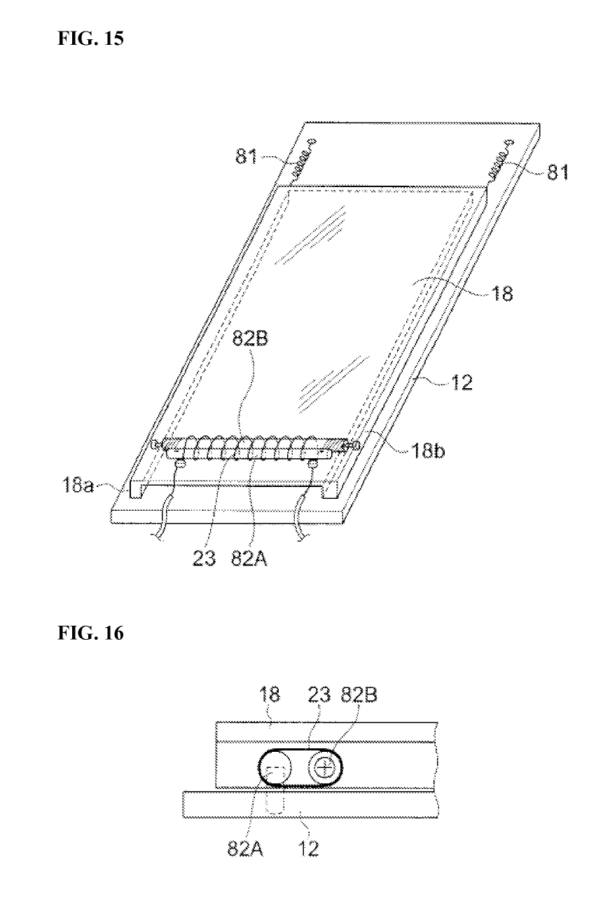

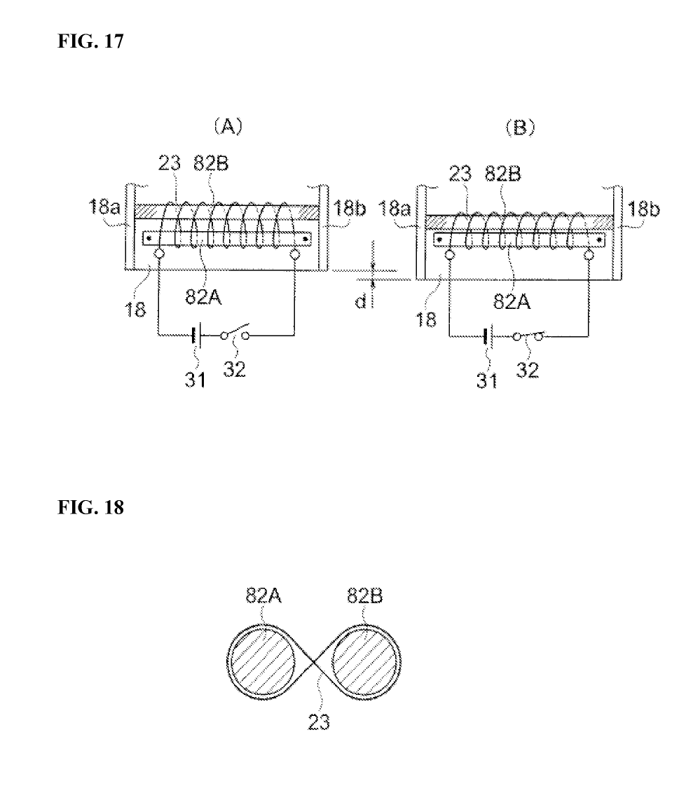

Next, referring to FIG. 15 to FIG. 18, a sixth embodiment of the haptic system according to the present invention will be explained. This embodiment as well is structured to generate a horizontal type click sensation. As shown in FIG. 15, a contact panel 18 is arranged to be freely movable in the up-down direction in FIG. 15 (horizontal direction with respect to display and operating surface) with respect to a printed circuit board 12 which is fastened to a box-shaped container 11 of a smartphone 10. The contact panel 18 is pulled upward by two extension springs 81. Further, at the vicinity of the bottom side of the circuit board 12, a for example round rod shaped insulating heat conductor 82A (fixed side) with two ends fastened to the printed circuit board 12 is provided. On the other hand, at the bottom side of the contact panel 18, a round rod shaped insulating heat conductor 82B (moving side) which is fastened between bent parts 18a, 18b is provided. Furthermore, around the two insulating heat conductors 82A, 82B, a wire-shaped shape memory alloy 23 is spirally wound. The two round rod shaped insulating heat conductors 82A, 82B are pulled by the extension springs 81 and are arranged at separated positions as shown in FIG. 16 and FIG. 17(A) in the state where the wire-shaped shape memory alloy 23 is not electrified. If the switch 32 is turned on and the wire-shaped shape memory alloy 23 is electrified, the wire-shaped shape memory alloy 23 contracts and the two round rod shaped insulating heat conductors 82A, 82B approach and change in positional relationship. As a result, the contact panel 18 is pulled downward and moves by exactly the distance “d”. In this way, at the front surface part of the smartphone 10, it is possible to make the contact panel 18 instantaneously move in a horizontal direction (up-down direction) parallel to the front surface part and possible to give a horizontal type click sensation.

Note that in the above explanation, the wire-shaped shape memory alloy 23 was wound in a spiral shape, but, as shown in FIG. 18, it may also be wound in a figure eight shape. In the embodiment in the case of winding the wire-shaped shape memory alloy 23, it is possible to use winding in a spiral shape or winding in a figure eight shape.

### Seventh Embodiment

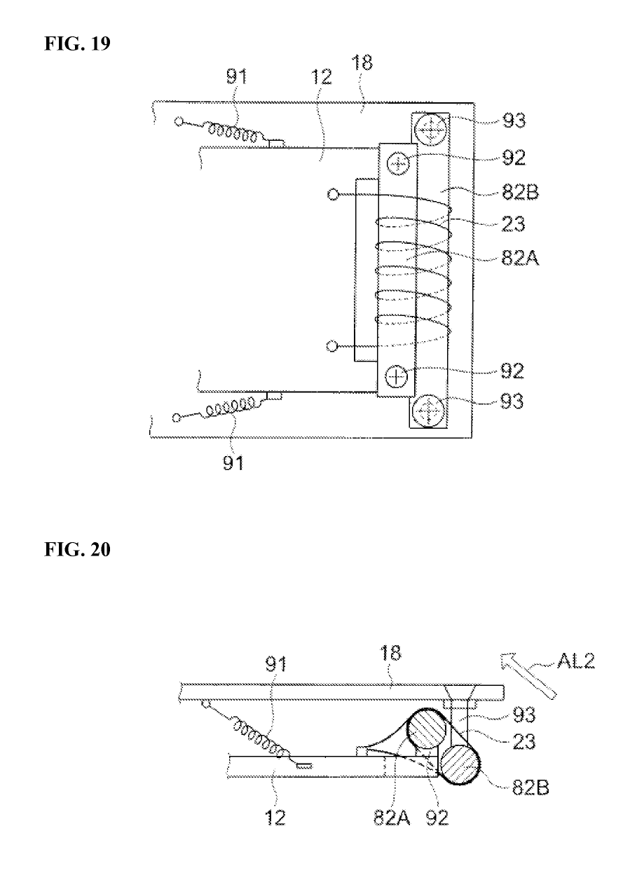

Next, referring to FIG. 19 and FIG. 20, a seventh embodiment of the haptic system according to the present invention will be explained. This embodiment is structured to generate a slanted up-down movement type of click sensation. The seventh embodiment is a modification of the sixth embodiment. FIG. 19 is a view seen from the front surface side which shows a printed circuit board 12, contact panel 18, and drive mechanism. The contact panel 18 is transparent, so is drawn in a state with the bottom side visible through it.

In FIG. 19 and FIG. 20, the fixed printed circuit board 12 has the contact panel 18 arranged at its front surface side and connected by extension springs 91. Furthermore, the printed circuit board 12 has a round rod shaped insulating heat conductor 82A fixed to its edge part by connecting members 92, while the contact panel 18 has the round rod shaped insulating heat conductor 82B fixed to it by connecting members 93. Around the two insulating heat conductors 82A, 82B, a wire-shaped shape memory alloy 23 is wound in a spiral shape. The insulating heat conductors 82A, 82B are arranged facing the upward direction at a slant as shown by the arrow AL2 in FIG. 20 due to their positional relationship as determined by their respective arrangement positions and the connecting members 91, 92 etc. That is, the two insulating heat conductors 82A, 82B are arranged in parallel between the contact panel 18 and the side part of the printed circuit board 12 and, further, are arranged so that the plane formed by the two insulating heat conductors 82A, 82B becomes slanted upward in direction with respect to the planar direction of the front surface. Note that the method of winding the wire-shaped shape memory alloy 23 may be a spiral shape or may be a figure eight shape.

When the wire-shaped shape memory alloy 23 is not being electrified, the contact panel 18 is pulled by the extension springs 91 to the printed circuit board 12 and the two insulating heat conductors 82A, 82B are separated in state. When the wire-shaped shape memory alloy 23 is being electrified, the wire-shaped shape memory alloy 23 contracts and the moving side insulating heat conductor 82B moves to approach the fixed side insulating heat conductor 82A. As a result, the contact panel 18 moves slanted upward in direction as shown by the arrow AL2. When the wire-shaped shape memory alloy 23 is no longer electrified, the original state is restored. In this way, by specially designing the method of attachment of the two round rod shaped insulating heat conductors 82A, 82B, the contact panel 18 can be moved instantaneously in a slanted direction upward whereby a click sensation is generated.

### Eighth Embodiment

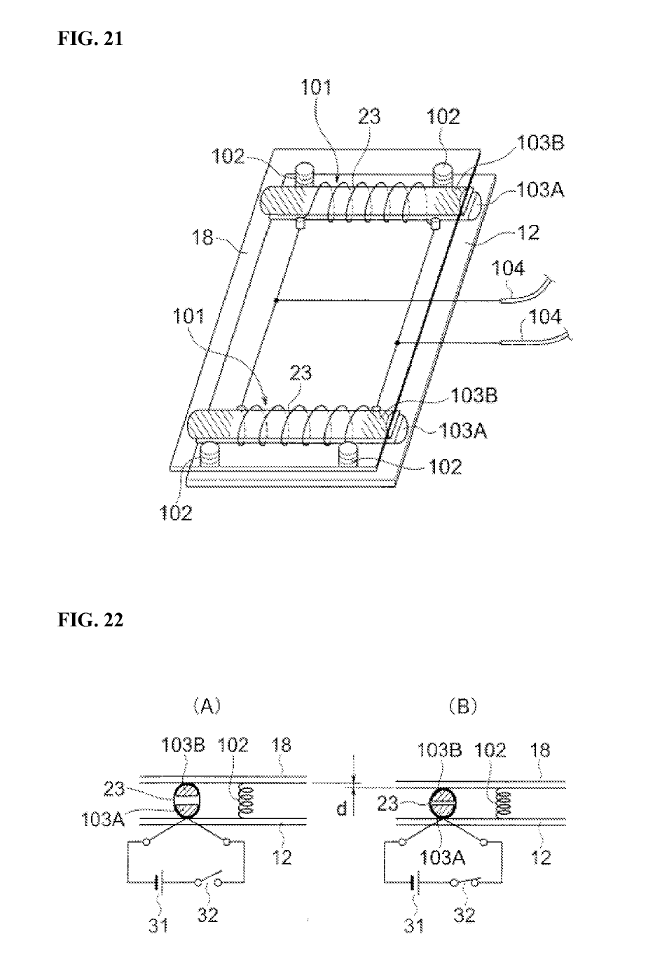

Next, referring to FIG. 21 to FIG. 23, an eighth embodiment of the haptic system according to the present invention will be explained. This embodiment is structured to generate a click sensation at the time of a push-in operation. In the smartphone 10 of the present embodiment, the contact panel 18 which is provided at the inside of the box-shaped container 11 is provided movably in only the thickness direction of the box-shaped container 11. The contact panel 18 can move to approach the printed circuit board 12 which is fastened inside of the box-shaped container 11. On the printed circuit board 12, a panel-type display device 15 and a touch panel 16 are provided.

As shown in FIG. 21, between the printed circuit board 12 and the contact panel 18, push-in type click generation mechanisms 101 are provided between the top side part and the bottom side part. Each of the click generating mechanisms 101 is configured by a compression spring (coil spring) 102 which is provided between the printed circuit board 12 and the contact panel 18, a fixed side insulating heat conductor 103A which is fastened to the printed circuit board 12, a moving side insulating heat conductor 103B which is fastened to the contact panel 18, and a wire-shaped shape memory alloy 23 which is spirally wound around the fixed side insulating heat conductor 103A and the moving side insulating heat conductor 103B. At each of the top side and bottom side push-in type click generating mechanisms 101, the wire-shaped shape memory alloy 23 is electrified at a suitable timing through an electrical cord 104.

When the wire-shaped shape memory alloy 23 is not electrified, as shown in FIG. 22 (A), due to the biasing action of the compression spring 102, the printed circuit board 12 and the contact panel 18 are at separated positions. The switch 32 turns on whereby the wire-shaped shape memory alloy 23 is electrified, the wire-shaped shape memory alloy 23 contracts, and the contact panel 18 displaces by exactly the distance “d” to the printed circuit board 12 side. In this way, due to the configuration of the push-in type click generating mechanism 101, it is possible to electrify the wire-shaped shape memory alloy 23 and thereby generate a push-in type click sensation.

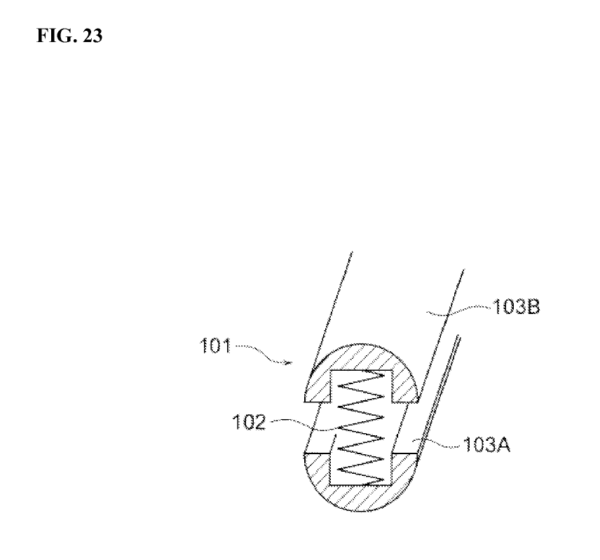

Note that regarding the push-in type click generating mechanism 101, as shown in FIG. 23, by making the compression spring 102 small in shape, it is possible to arrange it in the space between the fixed side insulating heat conductor 103A and the moving side insulating heat conductor 103B. Due to this, it is possible to make the click generating mechanism 101 small in size and a single piece.

### Ninth Embodiment

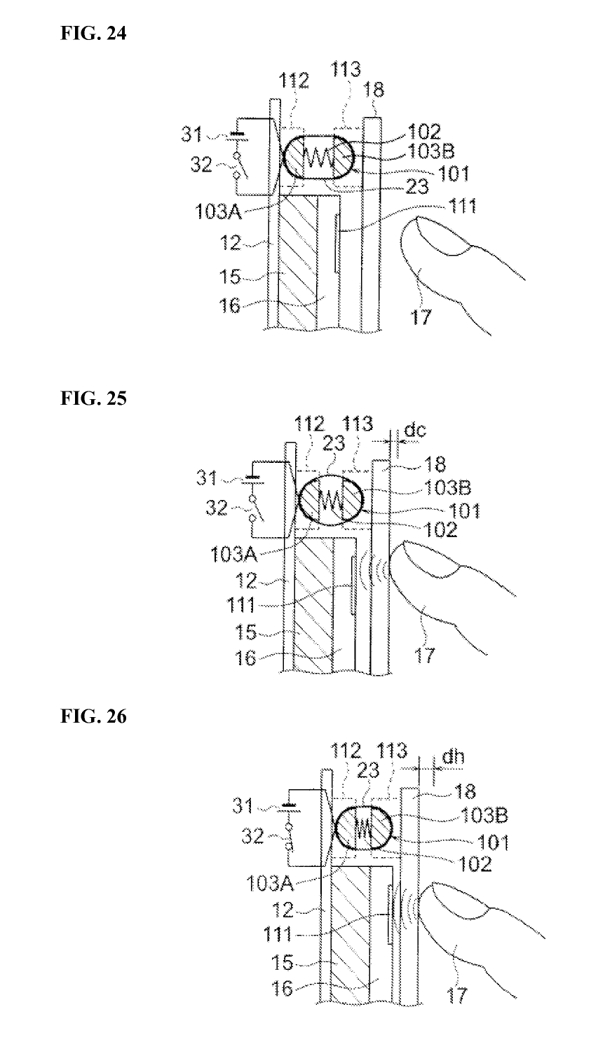

Next, referring to FIG. 24 to FIG. 26, a ninth embodiment of the haptic system according to the present invention will be explained. This embodiment is also structured to generate a click sensation at the time of a push-in operation. In the smartphone 10 of the present embodiment, the contact panel 18 which is provided at the inside of the box-shaped container 11 is provided to be able to move in only the thickness direction. In the longitudinal cross-sectional structure which is shown in FIG. 24, the contact panel 18 can move so as to approach a printed circuit board 12 which is fastened inside of the box-shaped container 11. On the printed circuit board 12, a panel-type display device 15 and a touch panel 16 are provided. Further, in FIG. 24 to FIG. 26, an electrode 111 which is formed on the surface of the touch panel 16 is illustrated as one example. In the usual state not operated by being touched, the contact panel 18 is arranged in a state a predetermined distance from the touch panel 16.

Between the printed circuit board 12 and the contact panel 18, a push-in type click generating mechanism 101 is provided between the top side part and the bottom side part (not shown). The click generating mechanism 101 has the structure which is shown in FIG. 23 and is comprised of a fixed side insulating heat conductor 103A which is fastened to the printed circuit board 12 by a fastening member 112, a moving side insulating heat conductor 103B which is fastened to the contact panel 18 by a fastening member 113, a coil spring shaped compression spring 102 which is arranged between the two insulating heat conductors 103A, 103B, and a wire-shaped shape memory alloy 23 which is wound around the two insulating heat conductors 103A, 103B.

FIG. 24 to FIG. 26 show the flow of operation of the click generating mechanism 101. In FIG. 24, a fingertip 17 is used to try to touch an electrode 111 of the touch panel 16. In the state where the fingertip 17 is separated from the touch panel 16, due to the action of the compression spring 102 of the click generating mechanism 101, the contact panel 18 is arranged in a state separated from the touch panel 16 by a predetermined distance.

In FIG. 25, a fingertip 17 contacts the contact panel 18 and pushes the contact panel 18 in by exactly a distance dc. At this time, the contact panel 18 is pushed down and the electrostatic capacitance between the electrode 81 and the fingertip 17 becomes larger whereby the fact of the touch panel 16 being operated is detected.

If operation is detected in this way, as shown in FIG. 26, the switch 32 is turned on, the wire-shaped shape memory alloy 23 contracts, and the contact panel 18 is pushed down further by the distance dh. In this way, the click generating mechanism 101 can be used to generate a pushdown type “click” sensation at the contact panel 18.

Here, it was explained that the click generating mechanism 101 was used to push down the contact panel 18. However, on the other hand, while not shown, it is also possible to change the method of attachment of the click generating mechanism 101 etc. and otherwise use a mechanism which changes the direction of generation of force so as to generate a pushdown type “click” sensation.

In the above embodiments, the explanation was given of an example where a touch panel 16 and a contact panel 18 are arranged on a panel-type display device 15 and the contact panel 18 is used as a moving member for generating a click sensation (information selection haptic panel), but the contact panel may be eliminated and the touch panel itself may be made to move. Further, an information selection haptic panel which is comprised of the touch panel 16 and the contact panel 18 superposed may be made to move. Furthermore, it is also possible to generate a clear click sensation by making the combination of the panel type display device 15 and the information selection haptic panel move as a whole.

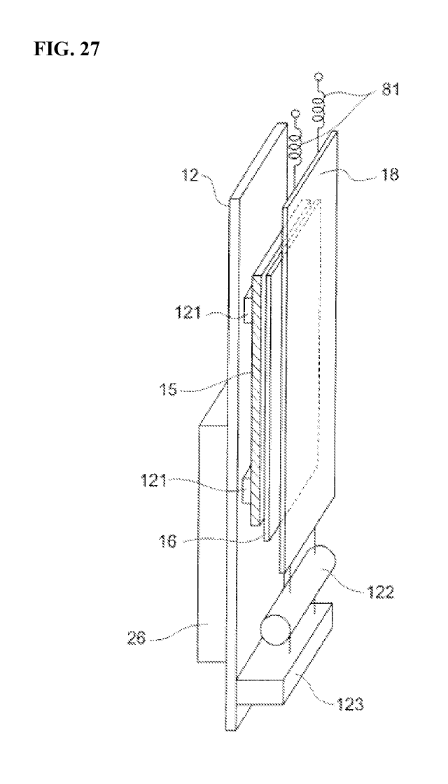

Referring to FIG. 27 to FIG. 29, an example of the constitution of the “information selection haptic panel” and the method of driving displacement will be explained.

FIG. 27 shows a structure comprised of a printed circuit board 12 on the back surface of which a battery 26 is attached. At the front surface side, a panel-type display device 15 and touch panel 16 are fastened through fasteners 121. At the front surface side of this touch panel 16, a contact panel 18 is provided slidable in the horizontal direction. Only the contact panel 18 is driven to displace and functions as an information selection haptic panel. This constitution is the same as the constitution which is shown in FIG. 15. Reference numeral 122 indicates an actuator, while 123 indicates a support mechanism which is fastened to the front surface of the printed circuit board 12 and houses the drive circuit. The actuator 122 is comprised of the above-mentioned insulating heat conductors 82A, 82B and the wire-shaped shape memory alloy 23. The contact panel 18 is pulled by the extension springs 81 and is driven to displace by the actuator 122 based on electrification from the drive circuit inside the support mechanism part 123.

According to the constitution which is shown in FIG. 27, only the contact panel 18 is made to move and there are no electrical circuit components on the contact panel 18, so the weight is reduced. Therefore, there is the advantage that a large acceleration can be obtained.

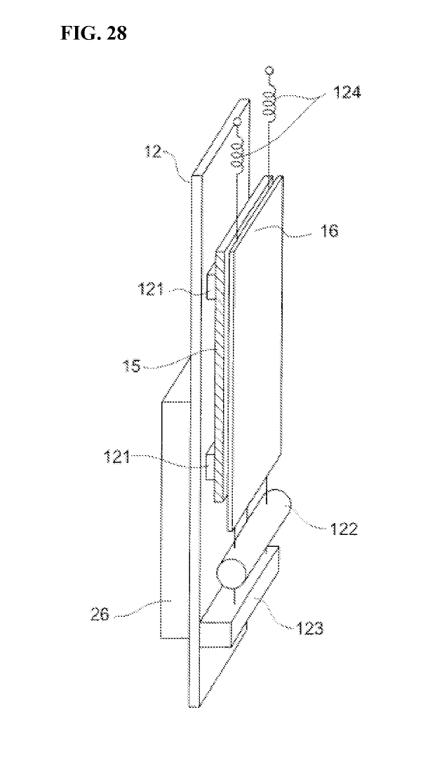

FIG. 28 shows a structure comprised of a printed circuit board 12 on the back surface of which a battery 26 is similarly attached. At the front surface side, a panel-type display device 15 is fastened through fasteners 121. At the front surface side of this panel-type display device 15, a touch panel 16 is provided slidable in the horizontal direction. In this constitution, only the touch panel 16 is driven to displace and functions as an information selection haptic panel. Reference numeral 122 is an actuator, while 123 is a support mechanism part. The touch panel 16 is pulled by extension springs 124 and is driven to displace by an actuator 128 due to electrification from the drive circuit inside of the support mechanism part 123. Note that, the connection circuit part of the touch panel 16 is fabricated by a flexible printed circuit board. The distance for drive for displacement of the touch panel 16 is at most within 0.5 mm, so the flexible printed circuit board does not greatly deform and does not become a large load on the actuator.

According to the constitution which is shown in FIG. 28, the above-mentioned contact panel 18 becomes unnecessary, so there is the advantage that increased thinness of the information selection haptic panel part can be realized.

The above explained panel-type display device 15 is generally a liquid crystal display device, organic EL display device, etc., but may also be a simple display device which utilizes light emission by LEDs.

Furthermore, the touch panel 16 is a generally an information input device which uses transparent electrodes, but it may also be an information input device which detects the approach of a finger of an operator using the action of the change in electrostatic capacitance. In this case, the transparency is not an issue. A simple assembly of electrodes is also possible.

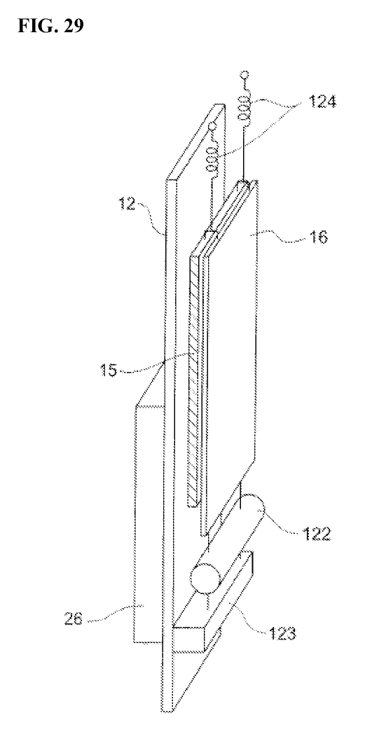

FIG. 29 shows a structure comprised of a printed circuit board 12 on the back surface of which a battery 26 is similarly attached. At the front surface side, a panel-type display device 15 and a touch panel 16 are overlaid and joined together. The assembly as a whole is provided to be able to slide in the horizontal direction. In this constitution, the panel-type display device 15 and the touch panel 16 as a whole are driven to displace and function as an information selection haptic panel. Reference numeral 122 indicates an actuator, while 123 indicates a support mechanism part. The panel-type display device 15 and the touch panel 16 are both tensed by the extension springs 124 and are driven to displace by the actuator 122 based on electrification from the drive circuit inside the support mechanism part 123. Note that, the connection circuit parts of the panel-type display device 15 and touch panel 16 are prepared by a flexible printed circuit board. The distance for the displacement drive is at most within 0.5 mm, so the flexible printed circuit board does not greatly deform and cause a great load on the actuator.

According to the constitution which is shown in FIG. 29, in the same way as the constitution of FIG. 28, the above-mentioned contact panel 18 becomes unnecessary and the fasteners 121 become unnecessary, so there is the advantage that increased thinness of the information selection haptic panel part can be achieved.

The configurations, shapes, sizes, and relative layouts explained in the above embodiments are only shown schematically to an extent enabling the present invention to be understood and worked. Further, the numerical values and compositions (materials) of the constitutions etc. are only illustrations. Therefore, the present invention is not limited to the embodiments explained above and can be changed in various ways so long as not departing from the scope of the technical ideas shown in the claims.

In particular, in the above embodiments, giving a physical operating sensation (click sensation) at the time of panel operation was explained, but this function may also be replaced with a vibration motor used in a conventional mobile phone etc.

### INDUSTRIAL APPLICABILITY

The haptic system according to the present invention can be utilized to generate a click sensation which gives a pseudo sense of operation to a fingertip at the time of touching a mobile phone, smartphone, or other similar electronic device which has an electrostatic capacitance type or other type of touch operation part.

### EXPLANATION OF REFERENCES

10 smartphone
11 box-shaped container
12 printed circuit board
15 panel-type display device
16 touch panel
18 contact panel
21 IC chip
22 camera
23 wire-shaped shape memory alloy
24 insulating heat conductor (heat sink)
25a linkage wire
25b linkage wire
26 battery
31 power source
32 switch
33 compression spring
41 insulating heat conductor
41a curved part
42 extension spring
51 compression spring
52 insulating heat conductor
52a curved part
61 insulating heat conductor
61A member
61B member
71A moving side insulating heat conductor
71B fixed side insulating heat conductor
72 extension spring (coil spring)
81 extension spring
82A insulating heat conductor (fixed side)
82B insulating heat conductor (moving side)
91 extension spring
101 push-in type click generating mechanism
102 compression spring (coil spring)
103A fixed side insulating heat conductor
103B moving side insulating heat conductor
111 electrode
121 fastener
122 actuator
123 support mechanism part
124 extension spring

1. A haptic system comprising:
a panel-type display device (15),
an information selection haptic panel (18) which is set on a top surface of said panel-type display device,
a shape memory alloy (23) which contracts upon electrification and heating to make said information selection haptic panel move, and
an insulating heat conductor (24, 41, 52, 61, 71A, 71B, 82A, 82B, 103A, 103B) which disperses heat which was generated by said shape memory alloy.

2. The haptic system as set forth in claim 1, wherein said information selection haptic panel is made to move by:
said information selection haptic panel which slides with respect to a display surface of said panel-type display device,
said insulating heat conductor (24) which is provided at a back surface side of said panel-type display device and which has a curved surface with which said shape memory alloy comes in contact when contracting,
wire links (25a, 25b) which are connected to said information selection haptic panel, and the contraction of said shape memory alloy.

3. The haptic system as set forth in claim 1, wherein said insulating heat conductor (24, 41, 52) which has a curved shape in a direction vertical to a direction of movement of said information selection haptic panel is connected to said information selection haptic panel, and said shape memory alloy comes in contact with said insulating heat conductor (24, 41, 52) at said curved surface when it contracts.

4. The haptic system as set forth in claim 1, wherein said insulating heat conductor includes:
a first insulating heat conductor (61A) which has a plurality of relief curved shapes in a direction of movement of said information selection haptic panel, the first insulating heat conductor being connected to said information selection haptic panel, and
a second insulating heat conductor (61B) which has a plurality of relief curved shapes facing said first insulating heat conductor (61A) across an interval, said shape memory alloy being laid between said first insulating heat conductor and said second insulating heat conductor so as to contact projecting parts of said first and second insulating heat conductors.

5. The haptic system as set forth in claim 1, wherein:
said information selection haptic panel slides in parallel with respect to a display surface of said panel-type display device,
said insulating heat conductor includes first and second insulating heat conductors, said first insulating heat conductor (71A) is connected to said information selection haptic panel, said second insulating heat conductor (71B) is overlaid facing the first insulating heat conductor, and said shape memory alloy is arranged between said first and second insulating heat conductors and makes said first insulating heat conductor and said information selection haptic panel move in parallel when said shape memory alloy contracts.

6. The haptic system as set forth in claim 1, wherein:
said information selection haptic panel slides with respect to a display surface of said panel-type display device,
said insulating heat conductor includes first and second insulating heat conductors, said first insulating heat conductor (82B) having a substantially round rod shape and being connected to said information selection haptic panel, and said second insulating heat conductor (82A) having a substantially round rod shape and being arranged in parallel with said first insulating heat conductor, and
said shape memory alloy being wound around said first and second insulating heat conductors.

7. The haptic system as set forth in claim 1, wherein:
said information selection haptic panel is elastically supported slanted in direction with respect to a display surface of said panel-type display device,
said insulating heat conductor includes first and second insulating heat conductors, said first insulating heat conductor (82B) having a substantially round rod shape, and said second insulating heat conductor (82A) having a substantially round rod shape which is arranged in parallel with said first insulating heat conductor in a slanted direction when viewed from a cross-sectional direction, and
said shape memory alloy is wound around said first and second insulating heat conductors.

8. The haptic system as set forth in claim 1, wherein:
said information selection haptic panel is elastically supported so as to move in a direction vertical to a display surface of said panel-type display device,
said insulating heat conductor includes first and second insulating heat conductors, said first insulating heat conductor (103B) having a substantially round rod shape which is connected to said information selection haptic panel, and said second insulating heat conductor (103A) having a substantially round rod shape which is arranged in parallel with said first insulating heat conductor, and
said shape memory alloy is wound around said first and second insulating heat conductors.

9. The haptic system as set forth in claim 8, wherein said shape memory alloy is wound in a spiral or a figure eight shape.

10. The haptic system as set forth in claim 1, wherein said insulating heat conductor includes first and second insulating heat conductors, said first and second insulating heat conductors (82A, 82B, 103A, 130B) have cross-sectional surface shapes of substantially circular or semicircular shapes.

11. A haptic system comprising:
a panel-type display device (15),
an information selection haptic panel which is arranged on a top surface of said panel-type display device and which has a touch panel (16) for selection of information and a contact panel (18) which is touched by a finger of an operator,
a shape memory alloy (23) which contracts upon electrification and heating to make said information selection haptic panel displace, and
an insulating heat conductor (24, 41, 52, 61, 71A, 71B, 82A, 82B, 103A, 103B) which disperses heat generated by said shape memory alloy,
wherein approach of the finger of the operator to said touch panel causing said shape memory alloy to be electrified and heated and causing said information selection haptic panel to displace.

12. The haptic system as set forth in claim 1, wherein said information selection haptic panel is a contact panel or a panel which is comprised of said contact panel and a touch panel (16).

13. The haptic system as set forth in claim 11, wherein at said information selection haptic panel, between said touch panel and said contact panel, only said contact panel is made to displace by said shape memory alloy.

14. The haptic system as set forth in claim 1, wherein said panel-type display device is fastened to said information selection haptic panel and moves simultaneously with movement of said information selection haptic panel.
